(19) United States
(12) Patent Application Publication
(10) Pub. No.: US 2024/0208551 A1
(43) Pub. Date: Jun. 27, 2024

(54) CIRCULATING CABLEWAY AND METHOD FOR OPERATING A CIRCULATING CABLEWAY

(71) Applicant: Innova Patent GmbH, Wolfurt (AT)

(72) Inventor: Clemens Mohr, Wolfurt (AT)

(21) Appl. No.: 18/392,522

(22) Filed: Dec. 21, 2023

(30) Foreign Application Priority Data
Dec. 22, 2022 (AT) A50992/2022

(51) Int. Cl. B61B 1/02; G06V 20/52; G06V 20/70

(52) U.S. Cl. CPC B61B 1/02; G06V 20/53; G06V 20/70

(57) ABSTRACT

In a circulating cableway including a number of cableway stations and a number of cableway vehicles movable between the cableway stations along a conveyor cable, a first cableway station includes a boarding region for passengers to board the cableway vehicles, a control unit for controlling the circulating cableway, and a detection device to detect passengers present in the boarding region and determine a passenger type for each of the detected passengers, wherein the control unit is designed to operate the circulating cableway in a specified safe operating mode when at least one determined passenger type is a specified safety passenger type, the circulating cableway also includes a lift platform with a height adjustment device in the boarding region, and the control unit is designed to control the height adjustment device in the specified safe operating mode to raise the lift platform to a specified or specifiable height.

### CROSS REFERENCE

The application claims the benefit of priority based on Austrian Patent Application No. A50992/2022, filed on Dec. 22, 2022, the disclosure of which is hereby expressly incorporated by reference herein in its entirety.

### TECHNICAL FIELD

The present disclosure relates to a circulating cableway having a number of cableway stations and a number of cableway vehicles that can be moved with a conveyor cable between the cableway stations, wherein a boarding region for passengers for boarding the cableway vehicles is provided in a first cableway station, and wherein a control unit is provided for controlling the circulating cableway, and wherein a detection device is provided in the first cableway station and is designed to detect passengers located in the boarding region and to determine a passenger type for each of the detected passengers, and the control unit is designed to operate the circulating cableway in a specified safe operating mode when at least one determined passenger type is a specified safety passenger type.

### BACKGROUND

In circulating cableways, the cableway vehicles are moved between two end stations in a circulating loop in a known manner. A distinction is basically made between chairlifts in which the cableway vehicles each have a chair for receiving passengers, and gondola lifts in which the cableway vehicles each have a gondola for receiving passengers. In addition, cableways, so-called combined cableways, are also known which enable mixed operation with gondola vehicles and chairlift vehicles. In modern circulating cableways, the cableway vehicles can be decoupled from the conveyor cable when they enter a cableway station, slowed down, and moved through the cableway station at a reduced speed. When exiting, the cableway vehicles can be accelerated back up to the speed of the conveyor cable and coupled to the conveyor cable. However, chairlifts are also known in which the chairlift vehicles are fixedly connected to the conveyor cable.

In the past, circulating cableways were used exclusively for passenger transport in ski resorts. This mainly involved transporting skiers with ski equipment between a valley station and a mountain station. Later, this also included snowboarders with snowboards. In the case of smaller cabins, the skis and snowboards are usually transported in standardized transport baskets which are provided for this purpose on the outside of the cabins. In the case of larger cabins, usually all of the equipment is transported inside the cabin. In the case of chairlifts, on the other hand, skis or snowboards usually remain attached to the legs during entry and exit and can be placed on suitable footrests during the ride. In addition to skis and snowboards, other, rather bulky winter sports equipment, such as snowbikes or sleds, have also come into use in recent years and usually have to be transported inside the cabin or fastened to the chair in a suitable manner.

Circulating cableways in ski resorts are also increasingly being used in the summer. In this case, passengers transport baby carriages, wheelchairs or mountain bikes, for example, which, due to their size, are usually also transported inside the cabins or, if necessary, on suitable holding devices on the chairlift vehicles. Recently, circulating cableways are also being used increasingly as public transport in the urban sphere. In this case, too, objects are often transported in addition to passengers, wherein the range of different object types is generally greater than in ski resorts. Especially in an urban area, in addition to the objects already mentioned, luggage items, e.g., suitcases or bags, or goods are often transported.

It can be seen that there is a large range of passenger types, which results in different challenges during boarding and exiting the cableway vehicles. While, for example, the entry of a passenger of the passenger type “Skier with ski equipment” can be managed relatively easily and quickly, the entry of passengers with unwieldy objects (e. g., passenger type “Person with item of luggage”, “Person with wheelchair”, “Person with bicycle”, “Person with stroller”, etc.) may be more complicated and therefore take more time. Different physical needs of the passengers can also play a role. For example, children, smaller adults, older people or people with handicaps often have problems when boarding a cableway vehicle, in particular chairlift vehicles, due to the speed of the cableway vehicles and/or due to the entry height.

In conventional circulating cableways, the cableway vehicles in normal operating mode are usually moved through the cableway station at a fixed, constant conveying speed. In the case of couplable cableways, the conveying speed of the decoupled cableway vehicles is generally lower than the speed of the conveyor cable, but is usually constant. In the case of non-couplable chairlifts, the conveying speed of the cableway vehicles corresponds to the speed of the conveyor cable. The conveying speed has previously only been changed by manual intervention by the operating personnel. In general, gondola lifts are always designed as a couplable cableway. The cabin doors are usually opened and closed automatically at fixed positions inside the cableway stations. The position, point in time, and available time for entry and exit are therefore fixed and cannot be changed in normal operating mode.

For certain passenger types, however, under certain circumstances, too little time remains for boarding or exiting. Taking into consideration the individual needs of the passengers is therefore generally not possible with conventional circulating cableways, or can take place at most by manual intervention of the operating personnel, by stopping the cableway, for example, or reducing the conveying speed. However, because the future trend is increasingly toward unattended operation, manual intervention is not a satisfactory solution. In addition, a reliable detection by the operating personnel of passenger types who may require more time for entry or exit cannot always be guaranteed due to distraction or other activities.

EP 3 888 993 A1 discloses an access control of a cableway as a function of the body height of the passengers, and operation of the cableway when children are detected due to the smaller body size. A barrier in the boarding region of the cableway is opened only when an adult is simultaneously present and wants to go through the barrier. This makes it possible to realize a safe operating mode of the cableway that is dependent on the passenger type. However, the entry of passengers into the cableway vehicle itself cannot be influenced or improved.

It is therefore an object of the present disclosure to provide a circulating cableway and a method for operating a circulating cableway which makes it possible to take into account individual needs of passengers during boarding.

### SUMMARY

The object is achieved with the cableway mentioned at the outset in that first a safety passenger type is determined by a detection device as described at the outset. As a result, it can automatically be determined whether there is a safety passenger type in the boarding region which has special requirements, for example with regard to the available entry time, and there can be an automatic response by triggering a suitable action in order to satisfy the needs of the safety passenger type.

According to the present disclosure, a lift platform for passengers having a height adjustment device is provided in the boarding region, and the control unit is designed to control the height adjustment device in safe operating mode in order to raise the lift platform to a fixed or specifiable height. As a result, the need of small persons, e.g. children, for a lower boarding height can be taken into account in the cableway vehicle.

Additionally or alternatively to the lift platform, a conveyor belt can also be provided in the boarding region for conveying the passengers in a direction of movement of the cableway vehicles, wherein the conveyor belt has a conveyor belt drive unit for driving the conveyor belt, and the control unit can be designed to control the conveyor belt drive unit in safe operating mode in order to reduce a conveyor belt speed of the conveyor belt to a specified or specifiable conveyor belt speed.

Alternatively or in addition to the lift platform, and optionally also in addition to the conveyor belt for conveying the passengers, a cableway drive device can be provided for driving the cableway vehicles, and the control unit can be designed to control the cableway drive device in safe operating mode to reduce a conveying speed of the cableway vehicles to a specified or specifiable conveying speed. The entry of passengers can thereby be facilitated.

It is advantageous if the cableway drive device has a conveyor cable drive unit for driving the conveyor cable and/or the cableway vehicles can be decoupled from the conveyor cable in the cableway station, wherein an auxiliary drive is provided for moving the decoupled cableway vehicles inside the first cableway station, and the cableway drive device has an auxiliary drive unit for the auxiliary drive. The speed of the conveyor cable can be adapted to a safety passenger type via the conveyor cable drive unit. The speed of the cableway vehicles decoupled from the conveyor cable in the cableway station can be adapted to a safety passenger type via the conveyor cable drive unit.

According to an advantageous embodiment, the detection device has at least one camera for capturing the boarding region and has an evaluation unit which is designed to detect the passengers located in the boarding region from a number of images captured by the at least one camera, and to determine the passenger type for each detected passenger. The at least one camera can, for example, comprise a conventional camera, a 3D camera or an infrared camera. An image recognition model, for example an artificial intelligence model (AI model), such as an artificial neural network, is preferably stored in the evaluation unit. From the camera images, the evaluation unit can hence determine a wide variety of (safety) passenger types. The image recognition model can, for example, be trained with a plurality of images of passengers whose passenger type is known. As a result, the image recognition model learns to distinguish normal passengers (e.g. adults without physical limitations) from safety passenger types. The image recognition model can optionally also be trained with current image data during operation in order to increase reliability or to add a new safety passenger type.

The determinable safety passenger type may include, for example, at least one of the following passenger types: Passenger below a specified height, Passenger above a specified height, Passenger with snowboard, Passenger with snowbike, Passenger with wheelchair, Passenger with bobsled or sled, Passenger with monoski, Passenger with bicycle, Passenger with luggage, Passenger with small child, Passenger with pet, Passenger with rescue equipment, in particular akia, and Passenger with walking aid. Of course, the enumeration is not exhaustive, and the determinable safety passenger types can be adapted to a specific cableway system. For example, the detection of a passenger with a snowboard in a cableway in an urban area is generally not required.

Preferably, at least two different safety passenger types are specified, wherein a first safe operating mode is specified for a first safety passenger type, and a second safe operating mode is specified for a second safety passenger type, which differs from the first safe operating mode. Different reactions can thereby be carried out for different safety passenger types. For example, a first height of the lift platform can be specified for the first safe operating mode, and a second height of the lift platform different from the first height can be specified for the second safe operating mode. Different heights can thereby be taken into account. A first conveyor belt speed of the conveyor belt can also be specified for the first safe operating mode, and a second conveyor belt speed of the conveyor belt different from the first conveyor belt speed can be specified for the second safe operating mode, and/or a first conveying speed of the cableway vehicles can be specified for the first safe operating mode, and a second conveying speed of the cableway vehicles different from the first conveying speed can be specified for the second safe operating mode. For example, different relative speeds between the cableway vehicle and the conveyor belt can thereby be set.

The circulating cableway can be designed as a chairlift, wherein the number of cableway vehicles are designed as chairlift vehicles, and wherein the boarding region comprises a chair boarding region for boarding the chairlift vehicles. Alternatively, the circulating cableway can also be designed as a gondola lift, wherein the number of cableway vehicles are designed as gondola vehicles, and wherein the boarding region comprises a gondola boarding region for boarding the gondola vehicles. Alternatively, the circulating cableway could also be designed as a combined cableway, wherein the number of cableway vehicles comprises a number of chairlift vehicles and a number of gondola vehicles, wherein the boarding region comprises a chair boarding region for boarding the chairlift vehicles and/or a gondola boarding region for boarding the gondola vehicles. The present disclosure can therefore be applied very flexibly to different types of circulating cableway.

An access region for access by the passengers to the boarding region can also be provided, wherein an automatic barrier device is preferably provided between the access region and the boarding region which is designed to release access for the passengers to the boarding region, and the detection device can be designed to determine the passengers types in the region between the access region and the boarding region, preferably in the region of the barrier device. As a result, the appropriate safe operating mode can be set predictively for the passengers in the access region.

In a second cableway station, an exit region for passengers can be provided for exiting the cableway vehicles, and the control unit can be designed to operate the circulating cableway again at an exit time in a specified safe operating mode at which a cableway vehicle with a passenger for which a safety passenger type has been determined in the first cableway station is located in the exit region. The safe operating mode can, for example, comprise a reduction in the conveying speed of the cableway vehicles so that exiting is facilitated. The exit time can, for example, be determined via the travel time of the cableway vehicle between the cableway stations. The travel time can be assumed to be known.

It can also be advantageous if each cableway vehicle has a unique vehicle ID, and the control unit is designed to determine the exit time on the basis of the vehicle ID. The vehicle ID can be, for example, a characteristic visual marking on the cableway vehicles which can be detected by the detection device, for example a QR code, a number, or the like. A separate first reading device could also be provided for reading the vehicle ID in the first cableway station, which communicates with the control unit of the cableway. If, for example, a barcode is provided as the vehicle ID, the first reading device could then comprise a barcode reader for reading the barcode. The vehicle could also be identified via near-field communication (NFC) or radio-frequency identification (RFID). For this purpose, a preferably passive transponder can be arranged on each of the cableway vehicles, and the first reading device could comprise a suitable NFC or RFID reader for reading the vehicle ID. In the second cableway station, a second reading device, which communicates with the control unit of the cableway, can be provided in an analogous manner for reading the vehicle ID. The second reading device can optionally also be designed as the detection device and, for example, comprise at least one camera and one evaluation unit.

The object is also achieved by the method mentioned at the outset in that passengers present in the boarding region are detected with a detection device, and a passenger type is determined for each of the detected passengers, and the control unit operates the circulating cableway in a specified safe operating mode if at least one determined passenger type is a specified safety passenger type.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 shows a view from above of a circulating cableway in the form of a chairlift.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

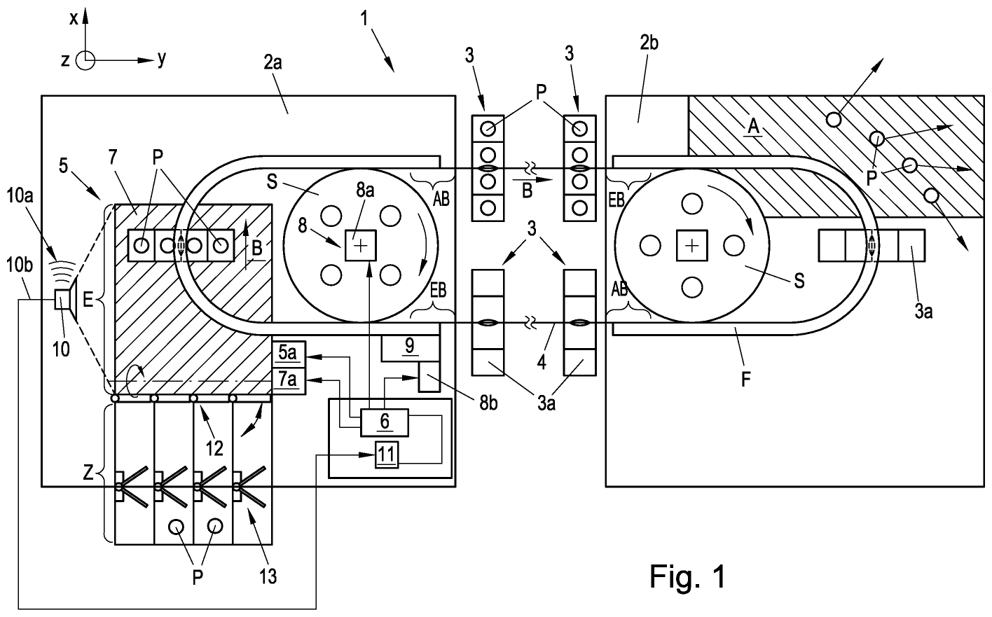

FIG. 1 shows a circulating cableway 1 having two cableway stations 2a, 2b. In the following, the term, “cableway,” is used synonymously for circulating cableway. The cableway 1 has a number of cableway vehicles 3 which can be moved between the cableway stations 2a, 2b by means of a conveyor cable 4. The first cableway station 2a and the second cableway station 2b are designed as end stations, at each of which the conveyor cable 4 is deflected around a pulley S in order to form a closed cable loop. The cableway vehicles 4 can be moved along this cable loop in a circulating movement. Optionally, one or more cableway stations (not shown), so-called mid-stations, can also be provided between the end stations 2a, 2b in a known manner, in which, in contrast to the end stations, no turning of the cableway vehicles 3 takes place.

The first cableway station 2a can, for example, be a valley station in a valley of a ski resort, and the second cableway station 2b can be a mountain station on a mountain of the ski resort. During operation of the cableway 1, passengers P are therefore transported predominantly from the valley station 2a to the mountain station 2b. However, transport from the mountain to the valley is also possible, of course. Of course, the use in a ski resort is only exemplary, and the cableway 1 could alternatively also be provided for urban operation, for example. In this case, a height difference does not necessarily have to be bridged, but it could also be a movement across a plane, or a movement with only a small height difference, or bridging of a river, etc. The passengers can also be transported in essentially equal parts in both directions.

Furthermore, a cableway drive device 8 is provided in the cableway 1 to drive the cableway vehicles 3. The cableway drive device 8 has a conveyor cable drive unit 8a, e.g. a suitable electric machine, for driving the conveyor cable 4. The conveyor cable drive unit 8a can be arranged, for example, in one of the cableway stations 2a, 2b and can be designed to drive the respective pulley S. In the illustrated embodiment according to FIG. 1, a conveyor cable drive unit 8a is provided in the first cableway station 2a by way of example. If necessary, however, further conveyor cable drive units 8a can also be provided in the other available cableway stations 2b in order to drive the respective pulleys S. This can be advantageous, for example, for allowing redundancy of the drive or for particularly large cable lengths and/or particularly large loads and/or large gradients.

The cableway 1 shown is designed as a chairlift in which the cableway vehicles 3 are designed as chairlift vehicles 3a. Each chairlift vehicle 3a has a chair for receiving a number of passengers P, e.g. four passengers, as indicated in FIG. 1. Alternatively, however, the cableway 1 could also be designed as a gondola lift in which the cableway vehicles 3 are designed as gondola vehicles (not shown). Each gondola vehicle has a gondola for receiving a plurality of passengers P, for example six passengers or more. In this case, a platform is provided in the cableway stations along which the gondola vehicles are moved and via which the passengers can board or exit the gondolas. An embodiment as a combined cableway would also be possible within the scope of the present disclosure. A combined cableway is a combination of a chairlift and gondola lift, wherein a number of chairlift vehicles and a number of gondola vehicles are moved alternatingly one behind the other on the conveyor cable. In the cableway stations, a boarding region for the chairlift vehicles and a boarding region separate therefrom for the gondola vehicles are generally provided. Gondola lifts and combined cableways are known in the prior art and therefore no detailed description is given here. For the sake of simplicity, the present disclosure is described with reference to the chairlift shown.

The cableway 1 is designed as a so-called couplable cableway in which the cableway vehicles 3 can be detachably coupled to the conveyor cable 4 in a known manner. Openable and closable detachable grips (not shown) are provided on the cableway vehicles 3 for this purpose. During travel on the free section between the cableway stations 2a, 2b, the detachable grip of a cableway vehicle 3 is closed, so that the cableway vehicle 3 is friction-locked to the conveyor cable 4. The drive force generated by the conveyor cable drive unit 8a is thereby transmitted frictionally via the detachable grip from the conveyor cable 4 to the cableway vehicle 3. During entering of the vehicle at a cableway station 2a, 2b, the detachable grip of a cableway vehicle 3 can be opened by an actuation device (not shown) in order to decouple the cableway vehicle 3 from the conveyor cable 4. While the conveyor cable 4 in normal operation is moved further around the pulley S at a substantially unchanged and constant conveying speed, the cableway vehicle 3 decoupled in the entering region EB can be decelerated after the decoupling and moved at reduced speed from the entering region EB to an exit region AB of the respective cableway station 2a, 2b. Boarding can thereby be facilitated, and a high conveying capacity can nevertheless be enabled.

In order to guide the cableway vehicles 3 decoupled from the conveyor cable 4, stationary guide rails F are provided in each of the cableway stations 2a, 2b. The guide rails F extend from the entering region EB to the exit region AB of each cableway station 2a, 2b. In the exit region AB, the cableway vehicles 3 can initially be accelerated back up to the conveying speed of the conveyor cable 4, and the detachable grips of the cableway vehicles 3 can be actuated by an actuation device (not shown) in order to re-couple the cableway vehicle 3 to the conveyor cable 4. A number of guide rollers (not shown) can be provided on each of the cableway vehicles 3, and, by means of the guide rollers, the cableway vehicles 3 can be guided along the guide rails F in the state in which they are decoupled from the conveyor cable 4.

In order to drive the decoupled cableway vehicles 3 along the guide rails F, an auxiliary drive 9 can be provided for each guide rail F in the cableway stations 2a, 2b. The auxiliary drive 9 is only schematically shown in FIG. 1, and can be designed, for example, in the form of a known tire conveyor, which has a plurality of driven tires arranged one after the other along each guide rail F. The tires can interact with friction linings on the cableway vehicles 3 in order to drive the cableway vehicles 3. A chain conveyor or toothed belt conveyor would also be conceivable. To drive the auxiliary drives 9, a suitable second drive unit 8b, e.g., an electric machine, can be provided in each case. The auxiliary drive unit 8b is indicated merely by way of example for the auxiliary drive 9 of the first cableway station 2a. Of course, an auxiliary drive 9 with an auxiliary drive unit 8b is preferably also provided in the second cableway station 2b in an analogous manner.

Furthermore, at least one control unit 6 for controlling functions of the cableway 1 is provided in the cableway 1. The control unit 6 serves, among other things, to control the drive device 8, in particular to control the available conveyor cable drive unit(s) 8a and to control the available auxiliary drive unit(s) 8b. In addition, the control unit 6 could of course also be designed to control further functions which, however, are not relevant to the present disclosure—for example, for lighting control, etc. The position of the control unit 6 is shown in FIG. 1 only by way of example in the first cableway station 2a and can, for example, be arranged in a control room for the cableway personnel. Of course, the control unit 6 can also be arranged in the second cableway station 2b or at any other suitable location on the cableway 1. The control unit 6 could also have several separate control units, for example, which communicate with one another via a suitable communications link. The control unit 6 can have suitable hardware and/or software.

In the first cableway station 2a, a boarding region E for passengers P for boarding the cableway vehicles 3, in this case the chairlift vehicles 3a, is provided. The position and size of the boarding region E depend on the capacity of the chairlift vehicles 3a and the specific embodiment and arrangement of the cableway station 2a. In the example shown, the boarding region E lies, for example, below the curved section of the guide rail F. The cableway vehicles 3 are accordingly moved along a curve through the boarding region E. Of course, however, the boarding region E could also, for example, be located below the straight section of the guide rail F in front of the exit region AB, so that the cableway vehicles 3 are moved along a straight line through the boarding region E.

Furthermore, in the example according to FIG. 1, an access region Z for access by the passengers P to the boarding region E is also provided which adjoins the boarding region E. An automatic barrier device 12 can be provided between the access region Z and the boarding region E and is designed to cyclically release or block the access for the passengers P to the boarding region E. It can thereby be ensured that only the number of passengers P corresponding to the number of seats reach the boarding region E. The automatic barrier device 12 can be controlled by the control unit 6 in order to open and close the automatic barrier device 12 at the correct time. The time of opening/closing depends on the distance between the cableway vehicles 3 and on the conveying speed of the cableway vehicles 3 and can be assumed to be known. As indicated in FIG. 1, a control device 13 can also be provided in the access region Z and is designed to perform a check of a access permission of the passengers P. The control device 13 can, for example, have a turnstile which only allows passage when the access permission is valid and otherwise blocks it. The access permission is preferably checked contactlessly, for example via NFC or RFID.

According to the present disclosure, a detection device is provided in the first cableway station 2a and is designed to detect passengers P located in the boarding region E and to ascertain a passenger type for each of the detected passengers P. In addition, the control unit 6 is designed to operate the circulating cableway 1 in a specified safe operating mode when at least one determined passenger type is a specified safety passenger type. Within the scope of the present disclosure, the safety passenger type that can be ascertained can comprise, for example, at least one of the following passenger types: “Passenger below a specific height”, “Passenger above a specific height, “Passenger with snowboard”, “Passenger with a snowbike”, “Passenger with a wheelchair”, “Passenger with a bobsled or sled”, “Passenger with a monoski”, “Passenger with a bicycle”, “Passenger with luggage”, “Passenger with small child”, “Passenger with a pet”, “Passenger with rescue equipment, in particular an akia”, and “Passenger with walking aid”. Of course, the list is to be understood as only exemplary and not exhaustive. Further suitable safety passenger types can be added if they are detectable by the detection device.

In the example shown, the detection device has at least one camera 10 for capturing the boarding region E, and an evaluation unit 11 which is designed to detect the passengers P present in the boarding region E from a number of images captured by the at least one camera 10, and to ascertain the passenger type for each detected passenger. In a simple embodiment, the at least one camera 10 can have a commercially available digital camera (photo and/or video camera). The at least one camera 10 can record a time sequence of images of the boarding region E. Alternatively or additionally, at least one camera 10 could also comprise a 3D camera or an infrared camera. Due to the spatial representation by a 3D camera, passenger types can be better recognized. An infrared camera can be advantageous when there is poor visibility or poor light conditions.

The at least one camera 10 is preferably mounted at a suitable location in the first cableway station 2a so that at least the boarding region E can be captured as far as possible without interference and as free as possible from weather influences. The camera 10 can, for example, be mounted in an upper region of the cableway station 2a on a stationary structure. The position of the camera 10 relative to the boarding region E is preferably selected in such a way that the best possible capture of the passengers P is possible. For example, the camera 10 can be arranged such that an image axis of the camera 10 is substantially normal to the boarding region E. In order to capture the passengers P from different perspectives, it can be advantageous if a plurality of cameras 10 are used which are arranged at different positions, for example a camera 10 for capturing the passengers P from the front and/or from the side.

The at least one camera 10 can be connected to the evaluation unit 11 via a suitable wireless communication link 10a, for example via radio or Bluetooth, and/or via a wired communication link 10b, for example via an electrical line. In the shown example, the evaluation unit 11 is integrated in the control unit 6, as symbolized by the frame in FIG. 1. The evaluation unit 11 can have suitable hardware and/or software. Alternatively, however, the evaluation unit 11 could also be designed as a separate unit which is arranged between the at least one camera 10 and the control unit 6. However, the evaluation unit 11 could also be integrated in the camera 10, for example, which is the case, for example, when using so-called familiar “smart cameras” which are used, for example, in industrial image processing. In this case, the unit consisting of the camera 10 and the evaluation unit 11 could be connected to the control unit 6 via the communication link 10, 10b.

In order to determine the (safety) passenger types from the image data of the camera 10, it is advantageous if an image recognition model is saved in the evaluation unit 11. A suitable algorithm in the form of artificial intelligence (AI model) can be used as an image recognition model, for example. Such an algorithm can, for example, be an artificial neural network, which enables machine learning. The AI model can first be trained with a plurality of image data of passengers whose passenger type is known. By corresponding training with images of known passenger types, the AI model learns to distinguish on its own non-critical passenger types (for which a safe operating mode is not to be triggered) from safety passenger types (for which a safe operating mode is to be triggered). Such image recognition models are known in the prior art and therefore no detailed description is given here. For use in the context of the present disclosure, a person skilled in the art can select a suitable image recognition model. Data for training can be generated, for example, by previous image acquisition on comparable cableways.

Some advantageous embodiments of the safe operating mode according to the present disclosure are described below which can be carried out by the control unit 6 when at least one passenger safety type is detected. The embodiments are of course only to be understood as an example and not restrictively. The described embodiments described below can be used individually or in combination within the scope of the present disclosure.

According to a first advantageous embodiment, the control unit 6 is designed to control the cableway drive device 8 (conveyor cable drive unit 8a and/or auxiliary drive unit 8b) in safe operating mode in such a way that a conveying speed of the cableway vehicles 3 (or at least the cableway vehicle 3 located in the boarding region E) is reduced to a specified or specifiable conveying speed. As a result, the passenger P for which a safety passenger type was detected by the detection device has more time for entry, compared to normal operation, into the cableway vehicle 3 in the boarding region E. Of course, the same also applies to the other passengers P who are present in the boarding region E at the same time as the detected safety passenger type. This allows the safety for passengers with special needs to be increased in terms of boarding time.

After a certain time has elapsed, the control unit 6 can then, for example, switch from safe operating mode back to normal operating mode in which the conveying speed is increased again to the specified standard speed. Alternatively, however, it could also be recognized via the detection device whether and when entry has been completed by the passengers P present in the boarding region E, and the control unit 6 could use this information to switch from safe operating mode back to the normal operating mode. Of course, an additional sensor device (not shown) could also be provided in order to detect a position of the cableway vehicle 3 in the cableway station 2a. The sensor device can be connected to the control unit 6 via a suitable sensor line. For example, an optical sensor such as a light barrier which can be arranged at a suitable position in the cableway station 2a, for example at the end of the boarding region E or in the direction of movement B after the boarding region E, would be conceivable. Depending on the sensor signal received, the control unit 6 could switch from safe operating mode to normal operating mode. Other sensors, for example inductive or capacitive proximity sensors, electrical position switches, or the like could also be used as a sensor device.

According to a further advantageous embodiment, a conveyor belt 7 can be provided in the boarding region E for conveying the passengers P in the direction of movement B of the cableway vehicles 3. In this case, the conveyor belt 7 has a suitable conveyor belt drive unit 7a for driving the conveyor belt 7, for example an electric motor. In this case, the control unit 6 is designed to control the conveyor belt drive unit 7a in safe operating mode such that a conveyor belt speed of the conveyor belt 7 can be set to a specified or specifiable conveyor belt speed. Such conveyor belts 7 are known in the prior art and are used mainly for cableways in which the chairlift vehicles 3a are fixedly connected to the conveyor cable 4. The chairlift vehicles 3a cannot therefore be decoupled from the conveyor cable 4 in the boarding region E so that, in contrast to the couplable cableway 1 shown in FIG. 1, the speed is not reduced. The chairlift vehicles 3a are accordingly moved at the speed of the conveyor cable 4 through the boarding region E, which naturally makes it difficult to board for the passengers P who are standing still. However, the conveyor belt 7 makes it possible for the passengers P located thereon to be moved at a specified or adjustable speed v>0 in the direction of movement B, whereby a relative speed between the cableway vehicle 3 and the passengers P is reduced, which considerably facilitates boarding because the impact speed is reduced.

In safe operating mode, for example, the conveyor belt speed (preferably combined with a reduction in the conveying speed of the conveyor cable 4 or the chairlift vehicles 3a) could then be reduced compared to normal operation so that getting on the conveyor belt 7 is facilitated for the passengers P, in particular for the detected safety passenger type. Of course, however, a combination of couplable cableway vehicles 3, which can be decoupled from the conveyor cable 4 within the cableway station 2a and can be moved through the boarding region E at reduced speed, and a conveyor belt 7 is also possible. In this case, for example, the conveying speed of the cableway vehicles 3 and the conveyor belt speed could be coordinated with one another in order to facilitate entry.

According to a further advantageous embodiment, a lift platform 5 for passengers P having a height adjustment device 5a can be provided in the boarding region E. In this case, the control unit 6 is designed to control the height adjustment device 5a in safe operating mode such that the lift platform 5 can be raised to a specified or specifiable height. This can be advantageous in particular if a passenger P below a specified minimum height, for example a child, is detected as a safety passenger type. The lift platform 5 can then be raised to a certain height in order to facilitate boarding for the passenger P in question. Of course, the lift platform 5 can, if necessary, again be combined with the conveyor belt 7 and/or with the adaptation of the conveying speed of the cableway vehicles 3. The height adjustment device 5a can, for example, have a number of electrically controllable actuators which suitably lift and lower the lift platform in sufficiently short time. For example, hydraulic cylinders, pneumatic cylinders or mechanical actuating drives would be conceivable as actuators.

According to an advantageous embodiment, two or more different safety passenger types can also be specified, wherein a first safe operating mode is specified for a first safety passenger type, and a second safe operating mode which differs from the first safe operating mode is specified for a second safety passenger type. The individual needs of the passengers P can thereby be taken into account even better.

For example, a first height of the lift platform 5 can be specified for the first safe operating mode, and a second height of the lift platform 5 different from the first height can be specified for the second safe operating mode. The entry height can thereby be automatically adapted to different heights. Alternatively or additionally, a first conveyor belt speed of the conveyor belt 7 can be specified for the first safe operating mode, and a second conveyor belt speed of the conveyor belt 7 different from the first conveyor belt speed can be specified for the second safe operating mode. Moreover, in addition or alternatively, a first conveying speed of the cableway vehicles 3 can be specified for the first safe operating mode, and a second conveying speed of the cableway vehicles 3 different from the first conveying speed can be specified for the second safe operating mode. More than two safe operating modes with different settings would naturally also be conceivable. With simultaneous detection of two different safety passenger types present in the boarding region E, the control unit 6 can, for example, define which safety passenger type has priority, and select the safe operating mode for this safety passenger type.

As mentioned above and as shown in FIG. 1, an automatic barrier device 12 can also be provided between the boarding region E and the access region Z. In this case, the detection device can be designed, for example, to detect the passengers present in the region of the barrier device 12 and to ascertain the passenger types. An appropriate safe operating mode can thereby be established in advance. For this purpose, the detection device can, for example, comprise at least a camera 10 for capturing the barrier device 12.

In the second cableway station 2b, an exit region A is provided for the passengers P for exiting the cableway vehicles 3, in this case in particular the chairlift vehicles 3a. The control unit 6 of the cableway 1 can also be designed to operate the cableway 1 again in a fixed safe operating mode at an exit time at which a cableway vehicle 3 is located in the exit region A of the second cableway station 2b with a passenger P for whom a safety passenger type was determined in the first cableway station 2a. As a result, the individual needs of the passengers P while exiting can also be taken into account, and exiting can accordingly be facilitated for the passengers P. The exit time can be determined by the control unit 6, for example on the basis of the running time of the cableway vehicle 3 between the boarding region E of the first cableway station 2a and the exit region A of the second cableway station 2b.

The running time is generally known or can be determined on the basis of a route length and a conveying speed. The route length can be assumed to be known, or could optionally also be measured. The conveying speed can also be assumed to be known or can optionally also be measured by a sensor, e.g., on the conveyor cable 4 or on the drive device 8, or can be determined from other available variables, e.g., a rotational speed of the first drive unit 8a. The control unit 6 can then calculate the exit time, e.g., starting from the entry time in the first cableway station 2a and on the basis of the running time between the boarding region E and the exit region A. The entry time can be that point in time at which a passenger P of a specified safety passenger type is detected by the detection device.

Alternatively or additionally, the exit time can also be ascertained using a unique vehicle ID of the cableway vehicles 3. For example, the detection device in the first cableway station 2a can be designed to ascertain the vehicle ID of the cableway vehicle 3 which is located in the boarding region E when a safety passenger type is detected, and to transmit it to the control unit 6. The control unit 6 can then, for example again on the basis of the running time, determine the exit time at which the cableway vehicle 3 is located with the relevant vehicle ID in the exit region A, and correspondingly switch to safe operating mode, for example for a specified duration.

In the first cableway station 2a, however, a separate first reading device (not shown) could also be provided in addition to the detection device for reading the vehicle ID of the cableway vehicle 3 located in the boarding region E when a safety passenger type is detected. The first reading device can be connected to the control unit 6 via a suitable wireless and/or wired communication link. The control unit 6 can in turn use the vehicle ID obtained by the first reading device to determine the exit time at which the relevant cableway vehicle 3 with the passenger P of the safety passenger type is located in the exit region A of the second cableway station 2b. This can be done again using the known running time of the cableway vehicle 3. As an alternative to determining the exit time via the running time, a second reading device for reading the vehicle ID could also be provided in the second cableway station 2b, which second reading device communicates with the control unit 6 in a suitable manner. The control unit 6 can use the vehicle ID obtained by the second reading device in order to determine the exit time and to switch the cableway 1 to a specified safe operating mode.

For example, the detection device can detect the passengers P present in the boarding region E (or in the region of the safety barriers 12) of the first cableway station 2a and ascertain the passenger type for each passenger P. The control unit 6 can use the information about the passenger types obtained by the detection device, e.g., the evaluation unit 11, in order to determine whether at least one of the passenger types is a saved safety passenger type. If this is the case, the control unit 6 can switch the circulating cableway 1, for example for a specified duration, to a specified safe operating mode. If no safety passenger type is detected, the cableway can continue to be operated in the normal operating mode.

In addition, the detection device or the first reading device can read the unique vehicle ID of the cableway vehicle 3 currently located in the boarding region E and also transmit it to the control unit 6. The control unit 6 can use the received vehicle ID to switch the circulating cableway 1 to a specified safe operating mode at an exit time at which the relevant cableway vehicle 3 is located in the exit area A of the second cableway station 2b, for example for a specified duration. As already mentioned, the exit time can be determined via the running time and/or by the second reading device arranged in the second cableway station 2b. Of course, a detection device analogous to the one in the first cableway station 2a can also be used as a second reading device, which has, for example, at least one camera 10 and an evaluation unit 11.

If the detection device (here a camera 10 and evaluation unit 11) is used to read the vehicle ID, a characteristic visual feature, for example, on the outside of the cableway vehicles 3, can then be used as a vehicle ID, which characteristic visual feature can be detected by the evaluation unit 11. A QR code, an identification number, or a unique image, which, for example, is in the form of a sticker, would be conceivable. The separate reading device for reading the vehicle ID could be, for example, a barcode reader, and a barcode could be used as a vehicle ID. The use of NFC or RFID would also be possible. In this case, a preferably passive transponder could in each case be provided on the cableway vehicles 3, and an NFC or RFID reader could be provided in the first cableway station 2a (and optionally in the second cableway station 2b) which can read the transponder.

According to another advantageous embodiment of the present disclosure, a signaling device (not shown in FIG. 1) can be provided in at least one of the cableway stations 2a, 2b, and the control unit 6 can be designed to control the signaling device to generate a signal when the circulating cableway 1 is in a safe operating mode. The signaling device can, for example, be provided for informing passengers and/or for informing the operating personnel (if present). The signaling device could be designed, for example, to output a visual and/or acoustic signal. For this purpose, the signaling device could have, for example, at least one signal lamp, and/or a screen, and/or a loudspeaker. The signaling device could also be designed, for example, to reproduce information as a signal, e.g., via a screen or a mobile device.

Finally, it is again noted that the described chairlift should only be understood as an example. The present disclosure could naturally also be used in an analogous manner in a gondola lift or in a combined cableway. If the circulating cableway 1 is designed as a gondola lift, the boarding region E for which the detection device is provided will comprise a gondola boarding region which serves for the passengers P to board the gondola vehicles. If the circulating cableway 1 is designed as a combined cableway, the boarding region E for which the detection device is provided can comprise the chair boarding region for the passengers P to board the chairlift vehicles 3a and/or the cabin boarding region for the passengers P to board the gondola vehicles.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

What is claimed is:

1. A circulating cableway having a number of cableway stations and a number of cableway vehicles which can be moved with a conveyor cable between the cableway stations, wherein a boarding region for passengers for boarding the cableway vehicles is provided in a first cableway station, and wherein a control unit is provided for controlling the circulating cableway, wherein a detection device is provided in the first cableway station which is designed to detect passengers present in the boarding region and to determine a passenger type for each of the detected passengers, and in that the control unit is designed to operate the circulating cableway in a specified safe operating mode when at least one determined passenger type is a specified safety passenger type, comprising:
a lift platform for passengers having a height adjustment device is provided in the boarding region, wherein the control unit is configured to control the height adjustment device in a safe operating mode to raise the lift platform to a specified or specifiable height.

2. The circulating cableway according to claim 1, further comprising a conveyor belt in the boarding region for conveying the passengers in a movement direction of the cableway vehicles, the conveyor belt having a conveyor belt drive unit for driving the conveyor belt, and the control unit configured to control the conveyor belt drive unit in the safe operating mode in order to reduce a conveyor belt speed of the conveyor belt to a specified or specifiable conveyor belt speed, and/or a cableway drive device for driving the cableway vehicles is provided, the control unit configured to control the cableway drive device in safe operating mode in order to reduce a conveying speed of the cableway vehicles to a specified or specifiable conveying speed.

3. The circulating cableway according to claim 1, wherein the detection device further comprises at least one camera configured to capture a number of images of the boarding region and an evaluation unit configured to detect the passengers present in the boarding region from the number of images captured by the at least one camera and to ascertain the passenger type for each detected passenger;
wherein the at least one camera preferably comprises at least one of a 3D camera and an infrared camera; and
wherein the evaluation unit comprises an image recognition model.

4. The circulating cableway according to claim 1, wherein the determined safety passenger type comprises at least one of the following passenger types:
passenger below a specified height, passenger above a specified height, passenger with snowboard, passenger with snowbike, passenger with wheelchair, passenger with bobsled or sled, passenger with monoski, passenger with bicycle, passenger with luggage, passenger with small child, passenger with pet, passenger with rescue equipment, in particular a rescue sled, and passenger with walking aid.

5. The circulating cableway according to claim 1, wherein at least two different safety passenger types are specified, wherein the safe operating mode comprises at least a first safe operating mode, specified for a first safety passenger type, and a second safe operating mode, which differs from the first safe operating mode and is specified for a second safety passenger type.

6. The circulating cableway according to claim 5, wherein operation of the circulating cableway is adjusted in at least one of the following aspects as a function of the safe operating mode:
a first height of the lift platform is specified for the first safe operating mode, and a second height of the lift platform different from the first height is specified for the second safe operating mode;
a first conveyor belt speed of a conveyor belt is specified for the first safe operating mode, and a second conveyor belt speed of the conveyor belt different from the first conveyor belt speed is specified for the second safe operating mode; and
a first conveying speed of the cableway vehicles is specified for the first safe operating mode, and a second conveying speed of the cableway vehicles different from the first conveying speed is specified for the second safe operating mode.

7. The circulating cableway according to claim 1, further comprising:
an access region adjacent to the boarding region;
an automatic barrier device between the access region and the boarding region, configured to cyclically release passenger access to the boarding region; and
wherein the detection device is configured to determine the passenger type in a region of the automatic barrier device.

8. The circulating cableway according to claim 1, further comprising:
a second cableway station that includes an exit region for passengers for exiting the cableway vehicles;
wherein the control unit is configured to operate the circulating cableway in a fixed safe operating mode at an exit time at which a cableway vehicle is located in the exit region with a passenger for which a specified safety passenger type was determined in the first cableway station;
wherein each cableway vehicle preferably has a unique vehicle ID; and
wherein the control unit is configured to determine the exit time on the basis of the unique vehicle ID.

9. A method for operating a circulating cableway having a number of cableway stations and a number of cableway vehicles movable between the number of cableway stations using a conveyor cable, wherein the circulating cableway is controlled by a control unit, and wherein a boarding region for passengers for boarding the cableway vehicles is provided in a first cableway station, wherein passengers present in the boarding region are detected by a detection device, and a passenger type is ascertained for each of the detected passengers, and in that the control unit operates the circulating cableway in a specified safe operating mode when at least one of the ascertained passenger types is a specified safety passenger type, comprising the steps of:
providing a lift platform for passengers in the boarding region; and
adjusting the lift platform in the specified safe operating mode to a specified or specifiable height.

10. The method according to claim 9, further comprising the steps of:
providing a conveyor belt for conveying the passengers in a direction of movement of the cableway vehicles in the boarding region, and further comprising at least one of the steps of when in the specified safe operating mode:
reducing a conveyor belt speed of the conveyor belt to a specified or specifiable conveyor belt speed; and
reducing a conveying speed of the cableway vehicles to a specified or specifiable conveying speed.

11. The method according to claim 9, further comprising the steps of:
capturing a number of images of the boarding area with at least one camera;
detecting the passengers in the boarding area with an evaluation unit using the number of images recorded by the at least one camera, the evaluation unit determining the passenger type for each detected passenger;
wherein the at least one camera is at least one of a 3D camera or an infrared; and
wherein the evaluation unit comprises an image recognition model.

12. The method according to claim 9, wherein at least one of the following passenger types is specified as the specified safety passenger type:
passenger below a specified height, passenger above a specified height, passenger with snowboard, passenger with snowbike, passenger with wheelchair, passenger with bobsled or sled, passenger with monoski, passenger with bicycle, passenger with luggage, passenger with small child, passenger with pet, passenger with rescue equipment, in particular a rescue sled, and passenger with walking aid.

13. The method according to claim 9, wherein at least two different safety passenger types are specified, wherein a first safe operating mode is specified for a first safety passenger type, and a second safe operating mode which differs from the first safe operating mode is specified for a second safety passenger type.

14. The method according to claim 13, further comprising at least one of the steps of:
a first height of the lifting platform is specified for the first safe operating mode, and a second height of the lifting platform different from the first height is specified for the second safe operating mode;
a first conveyor belt speed of the conveyor belt is specified for the first safe operating mode, and a second conveyor belt speed of the conveyor belt different from the first conveyor belt speed is specified for the second safe operating mode; and
a first conveying speed of the cableway vehicles is specified for the first safe operating mode, and a second conveying speed of the cableway vehicles different from the first conveying speed is specified for the second safe operating mode.

15. The method according to claim 9, further comprising the step of cyclically releasing the access for the passengers to the boarding region through an automatic barrier device located a region between the boarding region and an access region and wherein the detection device ascertains the passenger types in the region of the barrier device.

16. The method according to claim 9, further comprising the step of, in an exit region provided for passengers for exiting a cableway vehicle in a second cableway station, operating the circulating cableway with the control unit in the specified safe operating mode at an exit time at which the cableway vehicle is located in the exit region with a passenger for which a safety passenger type was determined in the first cableway station;
providing a unique vehicle ID for each cableway vehicle; and
wherein the control unit ascertains the exit time on the basis of the unique vehicle ID.
